(19) United States
(12) Patent Application Publication
(10) Pub. No.: US 2015/0354961 A1
(43) Pub. Date: Dec. 10, 2015

(54) Method for planning an agricultural post-processing operation

(71) Applicant: CLAAS SELBSTFAHRENDE ERNTEMASCHINEN GMBH, HARSEWINKEL (DE)

(72) Inventors: Max Reinecke, VERSMOLD (DE); FLORIAN KREIS, GUETERSLOH (DE); HANS-PETER GROTHAUS, BIELEFELD (DE); CHRISTIAN RUSCH, HARSEWINKEL (DE); CHRISTIAN SCHAEPERKOETTER, WERTHER (DE); THORSTEN SCHILLMOELLER, GUETERSLOH (DE); THILO STECKEL, GUETERSLOH (DE); ANJA WILSKE, HARSEWINKEL (DE); IVAN SMOLNIK, HARSEWINKEL (DE); THOMAS KERSTING, LANGEN BERG (DE)

(21) Appl. No.: 14/729,353

(22) Filed: Jun. 3, 2015

(30) Foreign Application Priority Data
Jun. 6, 2014 (DE) 102014108078.5

(51) Int. Cl. G01C 21/00; A01D 89/00

(52) U.S. Cl. CPC G01C 21/00; A01D 89/001

(57) ABSTRACT

A method for planning an agricultural post-processing operation along a post-processing route includes carrying out an agricultural pre-processing operation by a pre-processing machine along a pre-processing route, using a recording system to record the pre-processing route, determining the post-processing route to be worked by a post-processing machine on the basis of the recorded pre-processing route. The recording system records a processing setting of the pre-processing operation and the planning device determines the post-processing route on the basis of the processing setting.

### CROSS-REFERENCE TO A RELATED APPLICATION

The invention described and claimed hereinbelow is also described in German Patent Application DE 10 2014 108 078.5, filed on Jun. 6, 2014. The German Patent Application, the subject matter of which is incorporated herein by reference, provides the basis for a claim of priority of invention under 35 U.S.C. 119(a)-(d).

### BACKGROUND OF THE INVENTION

The present invention broadly to a method for planning an agricultural post-processing operation along a post-processing route.

In agriculture, various working processes are carried out regularly on a field having a crop. An initial processing operation, which is referred herein generally as a pre-processing operation, is followed by a second processing operation. The second processing operation is referred to herein as a post-processing operation. Further downstream processing operations also may be added. The pre-processing operation as well as the post-processing operation are usually carried out along a respective route, which also can be identical, where the route travelled by a respective processing machine. The post-processing operation is then carried out sooner or later after the pre-processing operation.

An example of such a pre-processing operation and such a post-processing operation are combining and subsequently collecting straw. In this case, the swath laid down by a combine harvester along the driving path thereof, where the driving path also can be referred to as the set wheel track, is picked up by a baler and is pressed into bales. In the simplest case, the baler, which is pulled by a tractor, can follow the driving path of the combine harvester. By referring to this example, it also becomes clear that the post-processing operation itself can function as a pre-processing operation for a further downstream processing operation. For instance, the bales that are discharged by the baler are collected by a recovery vehicle, which, in turn, follows the driving path of the baler, at least in sections.

Other examples of such a pre-processing operation and such a post-processing operation are the discharge of beets and potatoes by a harvesting machine and their subsequent pick-up, as well as plowing followed by sowing.

It also is known from DE 10 2005 047 306 A1 that the respective position of a processing machine during processing is detected and stored and, based on these stored positions, a track is defined, along which a downstream, further processing machine is guided. In this manner, the post-processing operation then can be automatically carried out along the particular route of the pre-processing operation.

A problem associated with this prior art, however, is that simply following or post-processing the driving or processing route of the pre-processing operation is not always the most efficient solution for the post-processing operation. For instance, it may be prudent and, therefore, more economical to use a baler to pick up the swath discharged by a combine harvester if the direction of travel of the post-processing baler is opposite to the discharge direction of the swath. A baler, however, discharges the picked-up straw in the form of bales and is therefore not loaded to an increasing extent.

In the case of a collecting vehicle used to pick up the bales, however, the collecting vehicle must return to an unloading station after having picked up a certain weight or volume of bales. When and how often this is required depends on the size and weight of the bales. The quality of the bales, e.g., the moisture content and density, also can play a role in picking up and discharging. A further complication can set in, for example, when the number of machines that are used simultaneously differs for the pre-processing operation and for the post-processing operation. In this case, simply following the pre-processing route for the post-processing operation is usually not very efficient.

### SUMMARY OF THE INVENTION

The present invention overcomes the shortcomings of known arts, such as those mentioned above.

To that end, the present invention provides a method for planning an agricultural post-processing operation along a post-processing route such that the planned post-processing route is improved in terms of the efficiency thereof.

In an embodiment, the invention provides a method for planning an agricultural post-processing operation along a post-processing route. The inventive method includes carrying out an agricultural pre-processing operation along a pre-processing route using a pre-processing machine, recording the pre-processing route using a recording system and determining the post-processing route to be worked by a post-processing machine during the post-processing operation by a planning device based on the recorded pre-processing route. The recording system records a processing setting of the pre-processing operation and the planning device determines the post-processing route based on the processing setting.

An essential aspect of the invention is the finding that recording not only the route to be worked by the corresponding pre-processing machine for the pre-processing operation, i.e., the pre-processing route, but also recording a processing setting of this pre-processing operation to enable the planning device to provide an improved basis for the determination of the route to be worked for the post-processing operation, i.e., the post-processing route. In other words, in addition to the pre-processing route per se, a processing setting of the pre-processing operation, e.g., a direction of travel, also is recorded and the post-processing route is determined on the basis of this combined basis. Sensor values, such as moisture content, also can be recorded and processed accordingly. In this sense, a processing setting is understood to mean a setting of the pre-processing operation, which is determined by the pre-processing operation or which can be selected while the pre-processing operation is being carried out.

In addition to the pre-processing route per se, the following should be delineated from such a processing setting; measured properties of the crop, the ground or the weather and any other ambient or environmental parameters that are not determined by is the pre-processing operation and are therefore not controlled by the pre-processing operation. Such a processing setting can be variable, in terms of time and location, along the pre-processing route. In this case, the special value of the processing setting along the pre-processing route is then also taken into account in the determination of the post-processing route.

### BRIEF DESCRIPTION OF THE DRAWINGS

Further features and advantages of the invention will become apparent from the description of embodiments that follows, with reference to the attached figures, wherein:

FIG. 1 depicts a schematic view of a field having a crop during an agricultural pre-processing operation and a post-processing operation, planned according to the inventive method.

### DETAILED DESCRIPTION OF THE PREFERRED EMBODIMENTS

The following is a detailed description of example embodiments of the invention depicted in the accompanying drawings. The example embodiments are presented in such detail as to clearly communicate the invention and are designed to make such embodiments obvious to a person of ordinary skill in the art. However, the amount of detail offered is not intended to limit the anticipated variations of embodiments; on the contrary, the intention is to cover all modifications, equivalents, and alternatives falling within the spirit and scope of the present invention, as defined by the appended claims.

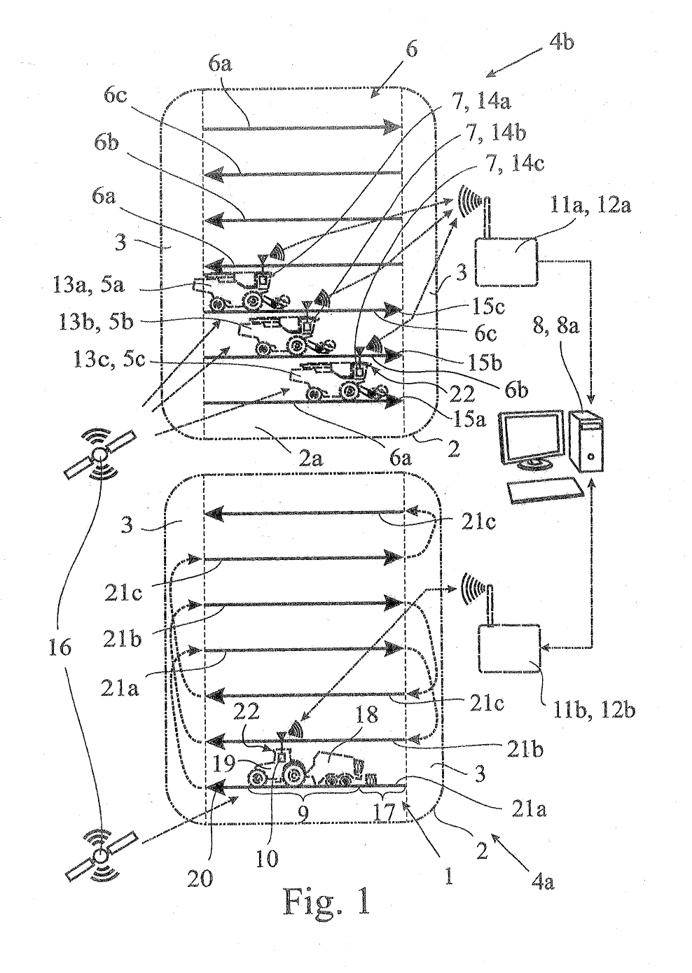

The inventive method is used to plan an agricultural post-processing operation along a post-processing route 1. The post-processing route 1 extends through afield 2 having a crop, wherein a crop region 2a of the field 2 is depicted in FIG. 1. The post-processing route 1 extends through a headland 3 of the field 2 and/or a region outside of the field 2 without crop. The post-processing route 1 is preferably continuous, although the route also can comprise non-continuous sections. The same field 2 having the headland 3 is depicted in FIG. 1 in a later momentary state 4a, i.e., during the post-processing operation, and in an earlier momentary state 4b, i.e., during a pre-processing operation, which is described in greater detail in the following.

According to the invention, the agricultural pre-processing operation is carried out by a pre-processing machine 5a, 5b, 5c along a pre-processing route 6. The pre-processing route 6 is preferably continuous. However, the pre-processing route 6 also can comprise non-continuous pre-processing route sections, as shown depicted in FIG. 1, and extend through a crop region 2a of the field 2, through the headland 3 of the field 2, and also through a region outside of the field 2 without crop. The pre-processing route 6 is not required to be straight, but rather can have any type of shape, in principle, and, in particular, can be curved.

The invention also includes that a recording system 7 records the pre-processing route 6 and, on the basis of the recorded pre-processing route 6, a planning device 8 determines the post-processing route 1 to be worked by a post-processing machine 9, for the purpose of post-processing. The planning device 8 can then transmit the determined post-processing route 1 to an execution system 10. The planning device 8, which is a central server 8a in the present case, can receive the recorded pre-processing route 6 by a first communication interface 11a, which can be a first GSM interface 12a in particular. Basically, however, any other type of transmission is possible, e.g., via a different mobile radio protocol, via WLAN, or also via a storage medium such as an SD card.

Likewise, the determined post-processing route 1 is transmitted via a second communication interface 11b and, in particular, a second GSM interface 12b, to an execution system 10. The second communication interface 11b and, therefore, the second GSM interface 12b, are preferably identical to the first communication interface 11a and the first GSM interface 11b, respectively. The aforementioned execution system 10 can basically be any type of device that executes or depicts at least a portion of the post-processing operation along the post-processing route 1, wherein examples thereof are described below.

The planning device 8 also can be disposed on the post-processing machine 9 or on one of the pre-processing machines 5a-c, optionally as a planning device 8 comprising a plurality of distributed individual devices. In particular, the planning device 8 can be formed by a control device of the post-processing machine 9 or the pre-processing machines 5a-c, which carries out further control tasks of the post-processing machine 9 or the pre-processing machine 5a-c, respectively. The planning device 8 also can be identical to the execution system 10. Finally, the planning device 8 also can be identical to the recording system 7.

In principle, the pre-processing route 6 can be any type of route. The pre-processing route 6 can correspond to the route that is travelled by the pre-processing machine 5a-c. The pre-processing route 6 also can be offset relative to the route that has been travelled such that the actual processing is carried out by the pre-processing machine 5a-c so as to be spaced apart from the driving route of the pre-processing machine 5a-c in the narrower sense. Likewise, the pre-processing route 6 can be defined by discharged objects, such as crop. This understanding of the pre-processing route 6 also applies similarly for the post-processing route 1.

The recording system 7 records a processing setting of the pre-processing operation and the planning device 8 determines the post-processing route 1, also on the basis of the detected processing setting. This processing setting is a machine setting or a process parameter of the pre-processing machine 5a-c during the pre-processing operation. Sensor values that relate to the crop or the crop properties, for example, also can be recorded and processed. In addition to the post-processing route, it also is possible to determine further parameters of the post-processing operation on the basis of the pre-processing route 6 and on the basis of the detected processing setting, such as processing settings of the post-processing operation. In this case, it is possible, in particular, to determine a post-processing direction on the post-processing route 1, wherein an example thereof is presented below. These additional parameters are then preferably also transmitted to the execution system 10.

The processing setting additionally may include additional information about the pre-processing route 6. For that matter, the processing setting goes beyond simple route information, which corresponds to the pre-processing route 6 or another route. Such additional information can be, e.g., a direction of travel 15a-c of the pre-processing machine 5a-c.

It is preferable that the pre-processing operation comprise the pre-processing of crop along the pre-processing route 6. The product that is the primary objective of the harvesting process in the narrower sense can be crop, e.g., corn, as well as other components of the crop, e.g., straw. In particular, this pre-processing operation can comprise the discharge of crop. In the exemplary embodiment shown in FIG. 1, three pre-processing machines 5a-c are depicted, i.e., combine harvesters 13a-c, which discharge straw as the crop, specifically in the form of a swath. The thusly discharged straw or the crop has a discharge direction, in particular, which is oriented opposite to the respective direction of travel of the combine harvester 13a-c in this case. The discharged crop can also be beets or potatoes, which are discharged in stacks.

Based thereon, the post-processing operation preferably comprises the post-processing of crop, which has been pre-processed and, in particular, discharged, in accordance with the aforementioned example, along the post-processing route 1. Such a post-processing operation can then include, in particular, the pick-up of discharged crop, wherein this preferably takes place in sections along the post-processing route 1. In other words, a post-processing operation is not carried out at certain other sections of the post-processing route 1, e.g., in the headland 3 in the example depicted in FIG. 1.

As an alternative, the pre- or post-processing operation also can comprise a plowing of the field 2, wherein a processing depth of the plowing could then be understood to be a processing setting. In this case, the post-processing route 1 is determined such that, e.g., ground is loosened at a deeper depth in a driving track of the pre-processing operation, since the ground was compressed to a greater extent there.

The processing setting recorded by the recording system 7 can be a property of the pre-processed crop. In this case, such a property is a property determined the processing of the crop and not only by the crop before the pre-processing operation, for example. In this case, the particular type of crop is not influenced by the pre-processing operation. Such a property, which is determined by the processing, can be a piece of information about orientation, dimensions and/or quality of the pre-processed crop. The piece of information related to dimensions can be, in particular, a dimension of the crop or a stack of this crop, such as a height, a width, or a length. These properties also can be determined by the compression with which the crop is discharged along the pre-processing route 6. In particular, the recorded processing setting can include a discharge direction of the discharged crop.

As shown in FIG. 1, it is possible for the pre-processing route 6 to be travelled by more than one pre-processing machine 5a-c and, therefore, for the pre-processing to be carried out by more than one pre-processing machine 5a-c. In this case, the recording system 7 preferably comprises at least one recording device 14a-c, each of which is assigned to a pre-processing machine 5a-c, respectively. It can then be provided that each pre-processing machine 5a-c carries out the pre-processing operation along a respectively assigned pre-processing section 6a, 6b, 6c of the pre-processing route 6.

The recording carried out by the recording system 7 can rely on different sources. In particular, the recording system 7 can comprise a sensor device that records the pre-processing route 6 and/or the processing setting, which is preferably the direction of travel 15a-c of the pre-processing machine 5a-c, respectively. The sensor device can be based on a GPS system 16 such that the processing setting can be more accurately assigned to the pre-processing route 6 along the course thereof, by GPS data.

In order to more precisely detect the pre-processing route 6, a position determination carried out by the GPS system 16 is supplemented with a recording of a driving track of the pre-processing route 6, which is carried out by a camera device 22, for example. The sensor device also can relate to other types of data, e.g., which are provided by radio or triangulation, for detecting and recording the pre-processing route 6.

Typically, there is a relatively long interval of time between the pre-processing operation and the post-processing operation. Therefore, the planning device 8 preferably determines the post-processing route 1 before the post-processing machine 9 begins the post-processing operation. The planning device 8 also transmits the post-processing route 1 to the execution system 10 before the post-processing operation is begun. This can take place, in particular, before the post-processing machine 9 travels along the post-processing route 1.

The planning device 8 can also determine the post-processing route 1 simultaneously with the execution of the post-processing operation. In particular, the planning device 8 determines the post-processing route 1 while the post-processing machine 9 is performing the post-processing operation and can transmit this post-processing route to the execution system 10. It also is possible for the planning device 8 to receive information about this from the post-processing machine 9 or from the execution system 10, e.g., via a transmission from the post-processing machine 9 by means of the second GSM interface 12b in the direction of the planning device 8, and to take into account whether and to what extent the post-processing machine 9 follows the post-processing route 1 that has been determined.

The post-processing machine 9 or the execution system 10 can receive this information by means of the above-mentioned GPS system 19. It also is possible for the planning device 8 to dynamically adjust the post-processing route 1 on the basis of a post-processing section 17 that has been worked up to that point. Preferably, the planning device 8 then also transmits the adjusted post-processing route 1 to the execution system 10. Such a deviation from the initially determined post-processing route 1 can occur, e.g., due to the unforeseen need to perform repair work on the post-processing machine 9. The change of course that is subsequently carried out by the post-processing machine 5a-c results in a change to the post-processing route 1 that was determined.

The method according to the invention is not limited to the consideration of a single field 2. Instead, according to a variant not depicted here, the pre-processing route 6 and the post-processing route 1 can extend through a plurality of fields 2 having crop, each of which is separated by at least one crop-free zone. The planning device 8 accounts for this plurality of fields 2 and the at least one crop-free zone in order to determine the post-processing route 1 in a corresponding manner.

Certain basic conditions can be placed on the post-processing operation or on the post-processing route 1. In this case, the planning device 8 preferably determines the post-processing route 1 on the basis of an optimization criterion, which can be defined by the user, in particular. Such an optimization criterion may comprise a plurality of aspects such that the optimization criterion preferably has a plurality of subcriteria.

The subcriteria also can be weighted differently in term of their significance. It also is possible for a prioritization to be assigned to each subcriterion and for the planning device 8 also to determine the post-processing route 1 on the basis of the assigned prioritizations of the subcriteria. These prioritizations are preferably user-defined, which gives the user the opportunity to apply weighting in a different, individualized manner.

In the case of straw that is discharged in a swath by a combine harvester 13a-c, it was determined that picking up the straw by a baler 18, which in combination with a tractor 19 for pulling the baler 18, is the post-processing machine 9 in the exemplary embodiment of FIG. 1, is more efficient and has a lower risk of malfunctioning when the pick-up is carried out counter to the discharge direction of the crop and therefore, in this case, in particular, counter to the discharge direction of the straw. Based on this determination, a corresponding optimization criterion or a subcriterion of such an optimization criterion can be derived as follows. Assuming that the discharge direction of the straw corresponds to the direction of travel 15a-c of the pre-processing machine 5a-c, i.e., the combine harvester 13a-c in this case, the post-processing machine 9 should therefore work and travel along the post-processing route 1 such that the post-processing direction 20 of the post-processing machine 9 on the corresponding sections of the post-processing route 1 is opposed to the direction of travel 15a-c of the pre-processing machine 5a-c, respectively.

Consequently, the planning device 8 determines a post-processing direction 20, which is assigned to the post-processing route 1 in sections, for the post-processing of the post-processing route 1 and preferably transmits this to the execution system 10, wherein the post-processing direction and can be a following direction. The optimization criterion can then include the requirement that the post-processing direction 20 on the post-processing route 1 is opposite the particular discharge direction of the discharged crop, which, in this case, is the direction of travel 15a-c of the pre-processing machine 5a-c, respectively.

As an alternative or in addition thereto, the optimization criterion can include further conditions or requirements, which, as an option, can be weighted with a respective prioritization as a subcriterion in the above-described sense. For example, the optimization criterion can be a minimization of the length of the post-processing route 1, a minimization of a processing time and/or a time it takes to travel along the post-processing route 1, a minimization of a fuel consumption of the post-processing machine 5a-c and/or maintenance of a maximum bale density and/or a maximum ground compression.

These criteria and other conceivable criteria can have complex interactions with one another. For example, the fuel consumption of the post-processing machine 9 depends on the particular post-processing machine 9, but also on the quantity and type of crop and on a topology of the field 2, e.g., in terms of height differences. The requirement of a bale density as a measure of how densely, e.g., a baler 18 compacts the picked-up straw to form a bale has implications, for example, for the speed that can be reached by the post-processing machine 9 on the post-processing route 1.

Similar to the recording system 7 according to the description presented above, the execution system 10 also can comprise a plurality of individual devices, as is the case with a variant that is not depicted here. Therefore, the execution system 10 preferably comprises a plurality of execution devices, each of which is respectively assigned to a post-processing machine 9.

The execution system 10 can be a device that depicts the post-processing route 1 determined by the planning device 8, e.g., by a visualization unit, such that an operator of the post-processing machine 9 can control this post-processing machine along the post-processing route 1 that has been determined. The execution system 10 also can comprise a steering device of the post-processing machine 9 or can be connected thereto for the purpose of exchanging messages such that the post-processing machine 9 is automatically kept on the post-processing route 1.

Furthermore, the execution system 10 also can control individual implements or other functional devices of the post-processing machine 5a-c. This can take place, e.g., according to the above-described further parameters of the post-processing operation, which the planning device 8 determined in addition to the post-processing route 1. In the case of a plurality of post-processing machines 9 in particular, the post-processing route 1 is typically subdivided into a plurality of post-processing sections 21, a, b, c. It can then be preferably provided that every post-processing machine 9 carries out the post-processing operation along a respectively assigned post-processing section 21a-c to be travelled along.

Finally, the planning device 8 preferably also determines the post-processing route 1 on the basis of performance parameters of the post-processing machine 9. An example of such a performance parameter would be, for example, the maneuverability of the post-processing machine 9, e.g., the aforementioned tractor 19 or the combined train of the tractor 19 and the baler 18. This can depend, e.g., on the type of route that must be travelled in the headland 3 or, optionally, outside of the headland 3 when the crop region 2a is exited and returned to. In the case of a plurality of post-processing machines 9, in particular, it also can be preferably provided that the planning device 8 determines the respectively assigned post-processing sections 21a-c on the basis of performance parameters of the respective post-processing machine 9, wherein, optionally, these performance parameters can also differ between the various post-processing machines 9.

### LIST OF REFERENCE SIGNS

1 post-processing route
2 field
2 a crop area
3 headland
4 a, b momentary state
5 a-c pre-processing machine
6 pre-processing route
7 recording system
8 planning device
8 a server
9 post-processing machine
10 execution system
11 a first communication interface
11 b second communication interface
12 a first GSM interface
12 b second GSM interface
13 a-c combine harvester
14 a-c recording device
15 a-c direction of travel
16 GPS system
17 post-processing section
18 baler
19 tractor
20 post-processing direction
21 a-c post-processing section
22 camera

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A method for planning an agricultural post-processing operation along a post-processing route, comprising:
carrying out an agricultural pre-processing operation along a pre-processing route using at least one pre-processing machine;
recording the pre-processing route using a recording system;
determining the post-processing route to be worked by a post-processing machine during the post-processing operation by a planning device based on the recorded pre-processing route;
wherein the recording system records a processing setting of the pre-processing operation; and
wherein the planning device determines the post-processing route based on the processing setting.

2. The method according to claim 1, wherein the processing setting includes additional information about the pre-processing route.

3. The method according to claim 1, wherein the pre-processing operation includes the pre-processing of crop by discharging the crop in a discharge direction, along the pre-processing route and wherein the post-processing operation includes the post-processing of the discharged crop along the post-processing route.

4. The method according to claim 3, wherein the post-processing operation includes the post-processing of the pre-processed crop discharged crop along the post-processing route, including pick-up of discharged crop.

5. The method according to claim 4, wherein the pick-up of discharged crop is in sections along the post-processing route.

6. The method according to claim 3, wherein the processing setting recorded by the recording system includes a property of the pre-processed crop comprising a piece of information about one or more of orientation, dimensions and quality of the pre-processed crop and wherein the recorded processing setting includes a discharge direction of the discharged crop.

7. The method according to claim 1, wherein the recording system comprises at least one recording device assigned to a respective one of the at least pre-processing machine, and wherein each pre-processing machine carries out the pre-processing along a respectively assigned pre-processing section of the pre-processing route.

8. The method according to claim 1, wherein the recording system comprises a sensor device that records the pre-processing route, the processing setting or both in a direction of travel of the pre-processing machine (5a-c).

9. The method according to claim 1, wherein the planning device determines the post-processing route before the post-processing operation is begun by the post-processing machine and transmits the post-processing route to an execution system.

10. The method according to claim 9, wherein the planning device determines the post-processing route before the post-processing route is travelled by the post-processing machine and transmits the post-processing route to an execution system.

11. The method according to claim 9, wherein the planning device determines the post-processing route during the post-processing by the post-processing machine and transmits the post-processing route to the execution system.

12. The method according to claim 1, wherein the planning device dynamically adjusts the post-processing route on the basis of a post-processing section that has been worked up to that point and, in particular, transmits the adjusted post-processing route to the execution system.

13. The method according to claim 1, wherein the planning device determines the post-processing route on the basis of an optimization criterion, which is user-defined.

14. The method according to claim 13, wherein the optimization criterion comprises a plurality of subcriteria.

15. The method according to claim 14, wherein a prioritization is assigned to each subcriterion and the planning device determines the post-processing route also on the basis of the assigned prioritizations of the subcriteria, and wherein the prioritizations are user-defined.

16. The method according to claim 15, wherein the planning device determines a post-processing direction assigned to the post-processing route in sections, for the post-processing of the post-processing route and transmits the post-processing direction to the execution system and wherein the optimization criterium includes the requirement that the post-processing direction on the post-processing route is opposite the respective discharge direction of the discharged crop.

17. The method according to claim 15, wherein the optimization criterion is any of the group consisting of: a minimization of a length of the post-processing route, a minimization of a processing time of the post-processing route, a minimization of a fuel consumption of the post-processing machine, maintenance of a maximum bale density and/or a maximum ground compression and a combination.

18. The method according to claim 1, wherein the execution system comprises a plurality of execution devices, each of which is assigned to each of a plurality of post-processing machines and wherein each of the post-processing machines carries out the post-processing along a respectively assigned post-processing section to be travelled along.

19. The method according to claim 1, further comprising a plurality of post-processing machines, wherein the planning device determines the post-processing route also on the basis of performance parameters of the post-processing machines and wherein the planning device determines a respectively assigned post-processing section on the basis of the performance parameters of the respective post-processing machines.
